(19) United States
(12) Patent Application Publication
(10) Pub. No.: US 2025/0286835 A1
(43) Pub. Date: Sep. 11, 2025

(54) COMBINING QUEUES IN A NETWORK DEVICE TO ENABLE HIGH THROUGHPUT

(71) Applicant: Marvell Asia Pte Ltd, Singapore (SG)

(72) Inventors: Srinivasan DK, Trichy (IN); Viraj Milind ATHAVALE, Bangalore (IN); Ashwin ALAPATI, San Jose, CA (US); William Brad MATTHEWS, Los Gatos, CA (US); Ajit Kumar JAIN, Milpitas, CA (US)

(21) Appl. No.: 19/074,152

(22) Filed: Mar. 7, 2025

Related U.S. Application Data
(60) Provisional application No. 63/562,556, filed on Mar. 7, 2024.

(51) Int. Cl. H04L 49/00

(52) U.S. Cl. CPC H04L 49/3036

(57) ABSTRACT

A network device includes network interfaces, and respective sets of queues. The sets of queues includes a first set corresponding to a first network interface and a second set corresponding to a second network interface. The network device receives packets via network interfaces, and processes packets to determine network interfaces via which the packets are to be transmitted. When the first network interface is not being used by the network device, the network device operates a composite queue to store packets corresponding to the second network interface. The composite queue includes a first queue from the first set and a second queue from the second set. The network device stores packet data to and reads packet data from the composite queue at a rate that is greater than a maximum rate at which the first queue and the second queue are capable of storing and reading packet data.

### CROSS-REFERENCES TO RELATED APPLICATIONS

This application claims the benefit of U.S. Provisional Patent Application No. 63/562,556, entitled “Notification Based Balancing,” filed on Mar. 7, 2024, which is incorporated herein by reference in its entirety for all purposes.

### FIELD OF TECHNOLOGY

The present disclosure relates generally to communication networks, and more particularly to buffering data units within a network device.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A computer network is a set of computing components interconnected by communication links. Each computing component may be a separate computing device, such as, without limitation, a hub, a switch, a bridge, a router, a server, a gateway, or personal computer, or a component thereof. Each computing component, or “network device,” is considered to be a node within the network. A communication link is a mechanism of connecting at least two nodes such that each node may transmit data to and receive data from the other node. Such data may be transmitted in the form of signals over transmission media such as, without limitation, electrical cables, optical cables, or wireless media.

The structure and transmission of data between nodes is governed by a number of different protocols. There may be multiple layers of protocols, typically beginning with a lowest layer, such as a “physical” layer that governs the transmission and reception of raw bit streams as signals over a transmission medium. Each layer defines a data unit (the protocol data unit, or “PDU”), with multiple data units at one layer combining to form a single data unit in another. Additional examples of layers may include, for instance, a data link layer in which bits defined by a physical layer are combined to form a frame or cell, a network layer in which frames or cells defined by the data link layer are combined to form a packet, and a transport layer in which packets defined by the network layer are combined to form a Transmission Control Protocol (TCP) segment or a User Datagram Protocol (UDP) datagram. The Open Systems Interconnection (OSI) model of communications describes these and other layers of communications. However, other models defining other ways of layering information may also be used. The Internet Protocol (IP) suite, or “TCP/IP stack,” is one example of a common group of protocols that may be used together over multiple layers to communicate information. However, techniques described herein may have application to other protocols outside of the TCP/IP stack.

A given node in a network may not necessarily have a link to each other node in the network, particularly in more complex networks. For example, in wired networks, each node may only have a limited number of physical ports into which cables may be plugged to create links. Certain “terminal” nodes-often servers or end-user devices—may only have one or a handful of ports. Other nodes, such as switches, hubs, or routers, may have a great deal more ports, and typically are used to relay information between the terminal nodes. The arrangement of nodes and links in a network is said to be the topology of the network, and is typically visualized as a network graph or tree.

A given node in the network may communicate with another node in the network by sending data units along one or more different “paths” through the network that lead to the other node, each path including any number of intermediate nodes. The transmission of data across a computing network typically involves sending units of data, such as packets, cells, or frames, along paths through intermediary networking devices, such as switches or routers, that direct or redirect each data unit towards a corresponding destination.

While a data unit is passing through an intermediary networking device—a period of time that is conceptualized as a “visit” or “hop”—the device may perform any of a variety of actions, or processing steps, with the data unit. The exact set of actions taken will depend on a variety of characteristics of the data unit, such as metadata found in the header of the data unit, and in many cases the context or state of the network device. For example, address information specified by or otherwise associated with the data unit, such as a source address, destination address, a virtual local area network (VLAN) identifier, path information, etc., is typically used to determine how to handle a data unit (i.e., what actions to take with respect to the data unit). For instance, an IP data packet may include a destination IP address field within the header of the IP data packet, based upon which a network router may determine one or more other networking devices, among a number of possible other networking devices, to which the IP data packet is to be forwarded.

In these and other contexts, a network device or other computing device often needs to temporarily store data in one or more memories or other storage media until resources become available to process the data. The storage media in which such data is temporarily stored is often logically and/or physically divided into discrete regions or sections referred to as data buffers (or, simply, “buffers”). The rules and logic utilized to determine which data is stored in what buffer is a significant system design concern having a variety of technical ramifications, including without limitation the amount of storage media needed to implement buffers, the speed of that media, how that media is interconnected with other system components, and/or the manner in the buffered data is queued and processed.

### SUMMARY

In an embodiment, a network device is configured to operate in a communication network. The network device comprises: a plurality of network interfaces, each network interface configured to i) receive packets, and ii) transmit packets; a plurality of sets of queues, each set of queues corresponding to a respective network interface amongst at least some network interfaces of the plurality of network interfaces, the plurality of sets of queues including a first set of queues corresponding to a first network interface and a second set of queues corresponding to a second network interface; a packet processor configured to process packets received via the plurality of network interfaces to determine network interfaces, amongst the plurality of network interfaces, via which the packets are to be transmitted; and queue management circuitry configured to, when the first network interface is not being used by the network device, operate a composite queue to store packet data corresponding to the second network interface, the composite queue including a first queue from the first set of queues and a second queue from the second set of queues, wherein the queue management circuitry is configured to at least one of i) store packet data to the composite queue at a first rate that is greater than a first maximum rate at which the first queue and the second queue are capable of storing packet data, and ii) read packet data from the composite queue at a second rate that is greater than a second maximum rate at which the first queue and the second queue are capable of reading packet data.

In another embodiment, a method is for processing packets in a network device having i) a plurality of network interfaces, and ii) a plurality of sets of queues, each set of queues corresponding to a respective network interface amongst at least some network interfaces of the plurality of network interfaces, the plurality of sets of queues including a first set of queues corresponding to a first network interface and a second set of queues corresponding to a second network interface. The method includes: receiving packets via a plurality of network interfaces of the network device; processing, by the network device, packets received via the plurality of network interfaces to determine network interfaces, amongst the plurality of network interfaces, via which the packets are to be transmitted; and when the first network interface is not being used by the network device, operating, by the network device, a composite queue to store packets corresponding to the second network interface, the composite queue including a first queue from the first set of queues and a second queue from the second set of queues, wherein operating the composite queue comprises at least one of i) storing packet data to the composite queue at a first rate that is greater than a first maximum rate at which the first queue and the second queue are capable of storing packet data, and ii) reading packet data from the composite queue at a second rate that is greater than a second maximum rate at which the first queue and the second queue are capable of reading packet data.

### BRIEF DESCRIPTION OF THE DRAWINGS

FIG. 1 is a simplified diagram of an example networking system in which one or more network devices are each configured to combine a first queue corresponding to a first port with a second queue corresponding to an inactive second port to form a composite queue that can operate at a higher speed than speeds at which the first queue and the second queue can operate individually, according to an embodiment.

FIG. 2 is a simplified diagram of an example network device that is configured to combine a first queue corresponding to a first port with a second queue corresponding to an inactive second port to form a composite queue that can operate at a higher speed than speeds at which the first queue and the second queue can operate individually, according to an embodiment.

FIG. 3A is a simplified block diagram of an example ingress queueing system of the network device of FIG. 2, according to an embodiment.

FIG. 3B is a simplified block diagram of the ingress queueing system of FIG. 3A operating in a state in which a first queue corresponding to a first port is combined with a second queue corresponding to an inactive second port to form a composite queue that can operate at a higher speed than speeds at which the first queue and the second queue can operate individually, according to an embodiment.

FIG. 3C is a simplified block diagram showing the ingress queueing system of FIG. 3B operating a composite queue for the first port when the second port is inactive, according to an embodiment.

FIG. 3D is a simplified block diagram showing the ingress queueing system of FIG. 3B operating a composite queue for the first port when the second port is inactive and third port is inactive, according to an embodiment.

FIG. 4 is a flow diagram of an example method for processing data units in a network device, such as the network device of FIG. 2, according to an embodiment.

### DETAILED DESCRIPTION

In the following description, for the purposes of explanation, numerous specific details are set forth in order to provide a thorough understanding of the present inventive subject matter. It will be apparent, however, that the present inventive subject matter may be practiced without these specific details. In other instances, well-known structures and devices are shown in block diagram form in order to avoid unnecessarily obscuring the present inventive subject matter.

A network device includes a plurality of network interfaces that are configured to be communicatively coupled to a plurality of communication links. The network device is configured to receive incoming data units, such as packets, frames, cells, etc., via the plurality of network interfaces, process the data units to determine network interfaces via which the data units are to be transmitted (sometimes referred to herein as “target network interfaces”), and forward the data units to the target network interfaces for transmission from the network device.

Data units are temporarily stored in one or more buffers while the data units are processed by the network device, e.g., to determine the target network interfaces via which the data units are to be transmitted, according to some embodiments. For example, incoming data units are temporarily stored in one or more ingress buffers while the data units are processed by the network device, e.g., to determine the target network interfaces via which the data units are to be transmitted, according to some embodiments. Then, the data units are transferred to one or more egress buffers associated with the target network interfaces, and temporarily stored in the egress buffers until the data units can be transmitted via the target network interfaces, according to some embodiments.

In some embodiments, the network device is configurable to operate at least some of the network interfaces at different transmission rates depending, for example, on a particular application and/or environment. At certain higher transmission rates, the network device cannot support all of the network interfaces, i.e., some of the network interfaces are put in an inactive state, according to some embodiments. As merely an illustrative example, a network device includes 512 network interfaces and supports operation of all 512 network interfaces when the network interfaces operate at transmission rates of 400 gigabits per second (G) or lower; but the network device supports at most 64 ports operating at 800 G.

In embodiments described below, a network device includes a plurality of network interfaces, and a plurality of sets of queues, each set of queues corresponding to a respective network interface, the plurality of sets of queues including a first set of queues corresponding to a first network interface and a second set of queues corresponding to a second network interface. When the first network interface is not being used by the network device, the network device operates a composite queue to store packets corresponding to the second network interface, the composite queue including a first queue from the first set of queues and a second queue from the second set of queues, according to an embodiment. The network device at least one of i) stores packets to the composite queue at a first rate that is greater than a first maximum rate at which the first queue and the second queue are capable of individually storing packet data, and ii) reads packets from the composite queue at a second rate that is greater than a second maximum rate at which the first queue and the second queue are capable of individually reading packet data, according to an embodiment. In some embodiments, operating the composite queue such as described above enables the network device to queue packet data for higher transmission rates without the need for higher speed memory or additional banks of memory.

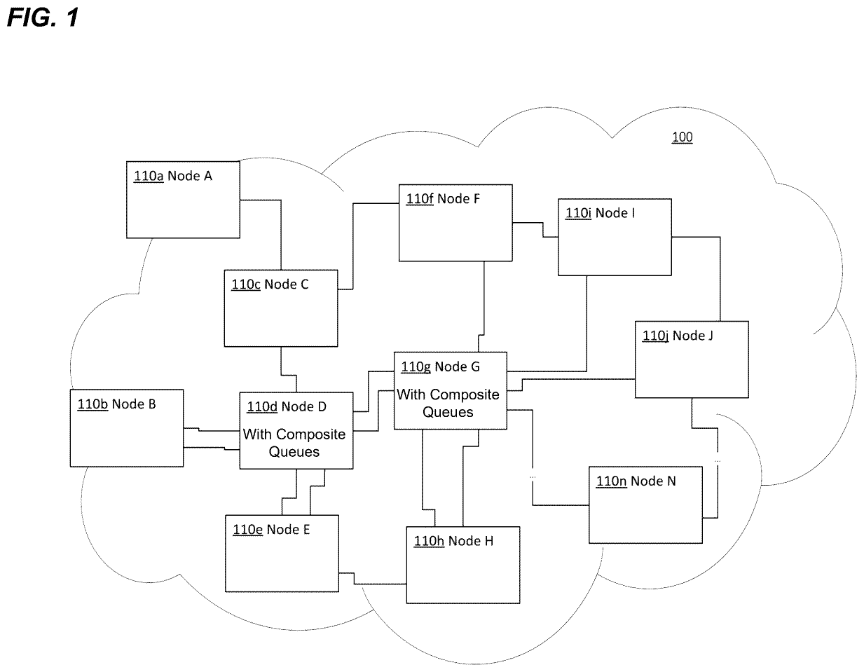

FIG. 1 is a simplified diagram of an example networking system 100, also referred to as a network, in which the techniques described herein are practiced, according to an embodiment. Networking system 100 comprises a plurality of interconnected nodes 110a-110n (collectively nodes 110), each implemented by a different computing device. For example, a node 110 may be a single networking computing device, such as a router or switch, in which some or all of the processing components described herein are implemented in application-specific integrated circuits (ASICs), field programmable gate arrays (FPGAs), or other suitable integrated circuit(s). As another example, a node 110 may include one or more memories storing machine-readable instructions for implementing various components described herein, one or more hardware processors configured to execute the instructions stored in the one or more memories, and various data repositories in the one or more memories for storing data structures utilized and manipulated by the various components.

Each node 110 is connected to one or more other nodes 110 in network 100 by one or more communication links, depicted as lines between nodes 110. The communication links may be any suitable wired cabling or wireless links. Note that networking system 100 illustrates only one of many possible arrangements of nodes within a network. Other networks may include fewer or additional nodes 110 having any suitable number of links between them.

While each node 110 may or may not have a variety of other functions, in an embodiment, each node 110 is configured to send, receive, and/or relay data to one or more other nodes 110 via communication links. In general, data is communicated as a series of discrete units or structures of data represented by signals transmitted over the communication links.

Different nodes 110 within a network 100 may send, receive, and/or relay data units at different communication levels, or layers. For instance, a first node 110 may send a data unit at the network layer (e.g., a TCP segment) to a second node 110 over a path that includes an intermediate node 110. The data unit may be broken into smaller data units (“subunits”) at various sublevels before it is transmitted from the first node 110. For example, the data unit may be broken into packets, then cells, and eventually sent out as a collection of signal-encoded bits to the intermediate device. Depending on the network type and/or the device type of the intermediate node 110, the intermediate node 110 may rebuild the entire original data unit before routing the information to the second node 110, or the intermediate node 110 may simply rebuild the subunits (e.g., packets or frames) and route those subunits to the second node 110 without ever composing the entire original data unit.

When a node 110 receives a data unit, the node 110 typically examines addressing information within the data unit (and/or other information within the data unit) to determine how to process the data unit. The addressing information may include, for instance, a media access control (MAC) address, an internet protocol (IP) address, a virtual local area network (VLAN) identifier, information within a multi-protocol label switching (MPLS) label, or any other suitable information. If the addressing information indicates that the receiving node 110 is not the destination for the data unit, the node may look up forwarding information within a forwarding database of the receiving node 110 and forward the data unit to one or more other nodes 110 connected to the receiving node 110 based on the forwarding information. The forwarding information may indicate, for instance, an outgoing port over which to send the data unit, a header to attach to the data unit, a new destination address to overwrite in the data unit, etc. In cases where multiple paths to the destination node 110 are possible, the forwarding information may include information indicating a suitable approach for selecting one of those paths, or a path deemed to be the best path may already be defined.

Addressing information, flags, labels, and other metadata used for determining how to handle a data unit are typically embedded within a portion of the data unit known as the header. One or more headers are typically at the beginning of the data unit, and are followed by the payload of the data unit. For example, a first data unit having a first header corresponding to a first communication protocol may be encapsulated in a second data unit at least by appending a second header to the first data unit, the second header corresponding to a second communication protocol. For example, the second communication protocol is below the first communication protocol in a protocol stack, in some embodiments.

For convenience, data units are sometimes referred to herein as “packets,” which is a term often used to refer to data units defined by the IP. The approaches, techniques, and mechanisms described herein, however, are applicable to data units defined by suitable communication protocols other than the IP. Thus, unless otherwise stated or apparent, the term “packet” as used herein should be understood to refer to any type of data structure communicated across a network, including packets as well as segments, cells, data frames, datagrams, and so forth.

Any node in the depicted network 100 may communicate with any other node in the network 100 by sending packets through a series of nodes 110 and links, referred to as a path. For example, Node B (110b) may send packets to Node H (110h) via a path from Node B to Node D to Node E to Node H. There may be a large number of valid paths between two nodes. For example, another path from Node B to Node H is from Node B to Node D to Node G to Node H.

In an embodiment, a node 110 does not actually need to specify a full path for a packet that it sends. Rather, the node 110 may simply be configured to calculate the best path for the packet out of the device (e.g., via which one or more egress ports should send the packet be transmitted). When a node 110 receives a packet that is not addressed directly to the node 110, based on header information associated with a packet, such as path and/or destination information, the node 110 relays the packet along to either the destination node 110, or a “next hop” node 110 that the node 110 calculates is in a better position to relay the packet to the destination node 110, according to some embodiments. In this manner, the actual path of a packet is product of each node 110 along the path making routing decisions about how best to move the packet along to the destination node 110 identified by the packet, according to some embodiments.

For each of one or more of the nodes 110, the node 110 combines a first queue corresponding to a first port with a second queue corresponding to an inactive second port to form a composite queue that can operate at a higher speed than speeds at which the first queue and the second queue can operate individually. For example, FIG. 1 depicts node 110d and node 110g as utilizing such composite queues.

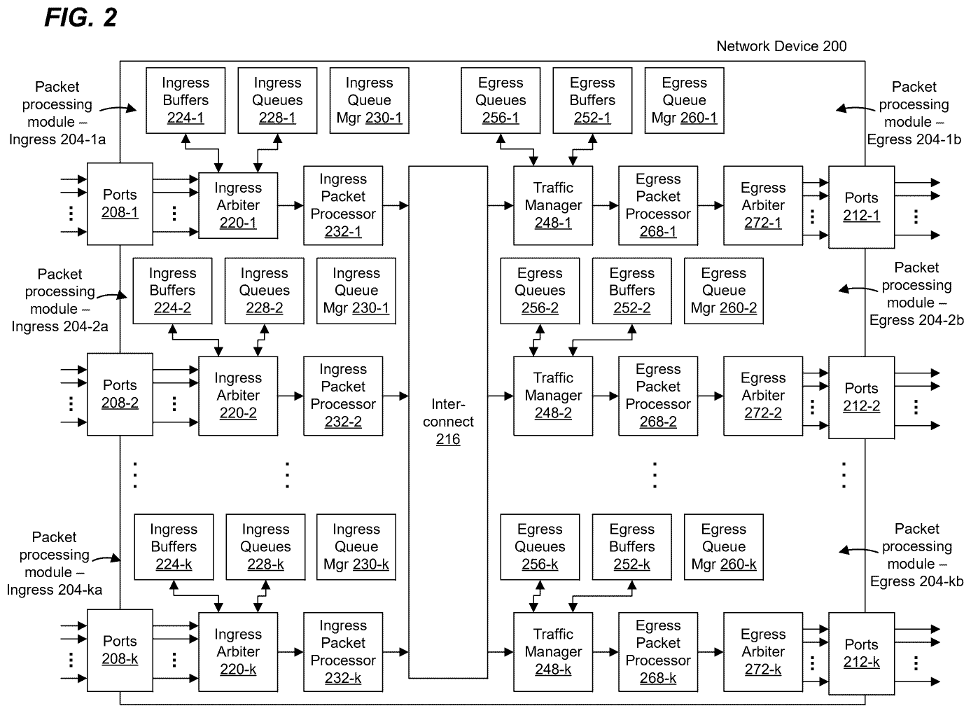

FIG. 2 is a simplified diagram of an example network device 200 that is configured to combines a first queue corresponding to a first port with a second queue corresponding to an inactive second port to form a composite queue that can operate at a higher speed than speeds at which the first queue and the second queue can operate individually, according to an embodiment. The network device 200 is a computing device comprising any combination of i) hardware and/or ii) one or more processors executing machine-readable instructions, being configured to implement the various logical components described herein.

In some embodiments, the node 110d and node 110g of FIG. 1 have a structure the same as or similar to the network device 200. In another embodiment, the network device 200 may be one of a number of components within a node 110. For instance, network device 200 may be implemented on one or more IC chips configured to perform switching and/or routing functions within a node 110, such as a network switch, a router, etc. The node 110 may further comprise one or more other components, such as one or more central processor units, storage units, memories, physical communication interfaces, LED displays, or other components external to the one or more IC chips, some or all of which may communicate with the one or more IC chips. In some such embodiments, the node 110 comprises multiple network devices 200.

In other embodiments, the network device 200 is utilized in a suitable networking system different than the example networking system 100 of FIG. 1.

The network device 200 includes a plurality of packet processing modules 204, with each packet processing module being associated with a respective plurality of ingress network interfaces 208 (sometimes referred to herein as “ingress ports” for purposes of brevity) and a respective plurality of egress network interfaces 212 (sometimes referred to herein as “egress ports” for purposes of brevity). The ingress ports 208 are ports by which packets are received via communication links in a communication network, and the egress ports 212 are ports by which at least some of the packets are transmitted via the communication links after having been processed by the network device 200.

Although the term “packet” is sometimes used herein to describe the data units processed by the network device 200, the data units may be packets, cells, frames, or other suitable structures. For example, in some embodiments the individual atomic data units upon which the depicted components operate are cells or frames. That is, data units are received, acted upon, and transmitted at the cell or frame level, in some such embodiments. These cells or frames are logically linked together as the packets to which they respectively belong for purposes of determining how to handle the cells or frames, in some embodiments. However, the cells or frames are not actually assembled into packets within device 200, particularly if the cells or frames are being forwarded to another destination through device 200, in some embodiments.

Ingress ports 208 and egress ports 212 are depicted as separate ports for illustrative purposes, but typically correspond to the same physical network interfaces of the network device 200. That is, a single network interface acts as both an ingress port 208 and an egress port 212, in some embodiments. Nonetheless, for various functional purposes, certain logic of the network device 200 may view a single physical network interface as logically being a separate ingress port 208 and egress port 212.

In some embodiments, at least some ports 208/212 are coupled to one or more transceivers (not shown in FIG. 2), such as Serializer/Deserializer (“SerDes”) blocks. For instance, ingress ports 208 provide serial inputs of received data units into a SerDes block, which then outputs the data units in parallel into a packet processing module 204. On the other end, a packet processing module 204 provides data units in parallel into another SerDes block, which outputs the data units serially to egress ports 212. There may be any number of input and output SerDes blocks, of any suitable size, depending on the specific implementation (e.g., four groups of 4×25 gigabit blocks, eight groups of 4×100 gigabit blocks, etc.).

Each packet processing module 204 comprises an ingress portion 204-xa and an egress portion 204-xb. The ingress portion 204-xa generally performs ingress processing operations for packets such as one of, or any suitable combination of two or more of: packet classification, tunnel termination, Layer-2 (L2) forwarding lookups, Layer-3 (L3) forwarding lookups, etc.

The egress portion 204-xb generally performs egress processing operations for packets such as one of, or any suitable combination of two or more of: packet duplication (e.g., for multicast packets), header alteration, rate limiting, traffic shaping, egress policing, flow control, maintaining statistics regarding packets, etc.

Each ingress portion 204-xa is communicatively coupled to multiple egress portions 204-xb via an interconnect 216. Similarly, each egress portion 204-xb is communicatively coupled to multiple ingress portions 204-xa via the interconnect 216. The interconnect 216 comprises one or more switching fabrics, one or more crossbars, etc., according to various embodiments.

In operation, an ingress portion 204-xa receives a packet via an associated ingress port 208 and performs ingress processing operations for the packet, including determining one or more egress ports 212 via which the packet is to be transmitted (sometimes referred to herein as “target ports”). The ingress portion 204-xa then transfers the packet, via the interconnect 216, to one or more egress portion 204-xb corresponding to the determined one or more target ports 212. Each egress portion 204-xb that receives the packet performs egress processing operations for the packet and then transfers the packet to one or more determined target ports 212 associated with the egress portion 204-xb for transmission from the network device 200.

In some embodiments, the ingress portion 204-xa determines a virtual target port and one or more egress portions 204-xb corresponding to the virtual target port map the virtual target portion to one or more physical egress ports 212. In some embodiments, the ingress portion 204-xa determines a group of target ports 212 (e.g., a trunk, a LAG, an ECMP group, etc.) and one or more egress portions 204-xb corresponding to the group of target ports selects one or more particular target egress ports 212 within the group of target ports. In the present disclosure, the term “target port” refers to a physical port, a virtual port, a group of target ports, etc., unless otherwise stated or apparent.

Each packet processing module 204 is implemented using any suitable combination of fixed circuitry and/or a processor executing machine-readable instructions, such as specific logic components implemented by one or more FPGAs, ASICs, or one or more processors executing machine-readable instructions, according to various embodiments.

In some embodiments, at least respective portions of multiple packet processing modules 204 are implemented on a single IC (or “chip”). In some embodiments, respective portions of multiple packet processing modules 204 are implemented on different respective chips.

In an embodiment, at least some components of each ingress portion 204-xa are arranged in a pipeline such that outputs of one or more components are provided as inputs to one or more other components. In some embodiments in which the components are arranged in a pipeline, one or more components of the ingress portion 204-xa are skipped or bypassed for certain packets. In other embodiments, the components are arranged in a suitable manner that is not a pipeline. The exact set and/or sequence of components that process a given packet may vary, in some embodiments, depending on the attributes of the packet and/or the state of the network device 200, in some embodiments.

Similarly, in an embodiment, at least some components of each egress portion 204-xb are arranged in a pipeline such that outputs of one or more components are provided as inputs to one or more other components. In some embodiments in which the components are arranged in a pipeline, one or more components of the egress portion 204-xb are skipped or bypassed for certain packets. In other embodiments, the components are arranged in a suitable manner that is not a pipeline. The exact set and/or sequence of components that process a given packet may vary, in some embodiments, depending on the attributes of the packet and/or the state of the network device 200, in some embodiments.

Each ingress portion 204-xa includes circuitry 220 (sometimes referred to herein as “arbitration circuitry”) that is configured to reduce traffic loss during periods of bursty traffic and/or other congestion. In some embodiments, the arbitration circuitry 220 is configured to function in a manner that facilitates economization of the sizes, numbers, and/or qualities of downstream components within the packet processing module 204 by more intelligently controlling the release of data units to these components. In some embodiments, the arbitration circuitry 220 is further configured to support features such as lossless protocols and cut-through switching while still permitting high rate bursts from ports 208.

The arbitration circuitry 220 is coupled to an ingress buffer memory 224 that is configured to temporarily store packets that are received via the ports 208 while components of the packet processing module 204 process the packets.

Each data unit received by the ingress portion 204-xa is stored in one or more entries within one or more buffers, which entries are marked as utilized to prevent newly received data units from overwriting data units that are already buffered in the buffer memory 224. After a data unit is released to an egress portion 204-xb, the one or more entries in which a data unit is buffered in the ingress buffer memory 224 are then marked as available for storing newly received data units, in some embodiments.

Each buffer may be a portion of any suitable type of memory, including volatile memory and/or non-volatile memory. In an embodiment, the ingress buffer memory 224 comprises one or more single-ported memories that each support only a single input/output (I/O) operation per N clock cycles, where N is a suitable integer greater than one (i.e., either a single read operation or a single write operation per N clock cycles). In an embodiment, N is four. In another embodiment, N is two. In other embodiments, N is another suitable integer. Single-ported memories are utilized for higher operating frequency, though in other embodiments multi-ported memories are used instead. In an embodiment, the ingress buffer memory 224 comprises multiple physical memories that are capable of being accessed concurrently in a same clock cycle, though full realization of this capability is not necessary. In an embodiment, each buffer is a distinct memory bank, or set of memory banks. In yet other embodiments, different buffers are different regions within a single memory bank. In an embodiment, each buffer comprises many addressable “slots” or “entries” (e.g., rows, columns, etc.) in which data units, or portions thereof, may be stored.

Generally, buffers in the ingress buffer memory 224 comprises a variety of buffers or sets of buffers, each utilized for varying purposes and/or components within the ingress portion 204-xa.

The ingress portion 204-xa comprises a buffer manager (not shown) that is configured to manage use of the ingress buffers 224. The buffer manager performs, for example, one of or any suitable combination of the following: allocates and deallocates specific segments of memory for buffers, creates and deletes buffers within that memory, identifies available buffer entries in which to store a data unit, maintains a mapping of buffers entries to data units stored in those buffers entries (e.g., by a packet sequence number assigned to each packet when the first the first data unit in that packet was received), marks a buffer entry as available when a data unit stored in that buffer is dropped, sent, or released from the buffer, determines when a data unit is to be dropped because it cannot be stored in a buffer, performs garbage collection on buffer entries for data units (or portions thereof) that are no longer needed, etc., in various embodiments.

The buffer manager includes buffer assignment logic (not shown) that is configured to identify which buffer, among multiple buffers in the ingress buffer memory 224, should be utilized to store a given data unit, or portion thereof, according to an embodiment. In some embodiments, each packet is stored in a single entry within its assigned buffer. In yet other embodiments, a packet is received as, or divided into, constituent data units such as fixed-size cells or frames, and the constituent data units are stored separately (e.g., not in the same location, or even the same buffer).

In some embodiments, the buffer assignment logic is configured to assign data units to buffers pseudorandomly, using a round-robin approach, etc. In some embodiments, the buffer assignment logic is configured to assign data units to buffers at least partially based on characteristics of those data units, such as corresponding traffic flows, destination addresses, source addresses, ingress ports, and/or other metadata. For example, different buffers or sets of buffers are utilized to store data units received from different ports 208/212 or sets of ports 208,212. In an embodiment, the buffer assignment logic also or instead utilizes buffer state information, such as utilization metrics, to determine to which buffer a data unit is to be assigned. Other assignment considerations include buffer assignment rules (e.g., no writing two consecutive constituent parts of a same packet to the same buffer) and I/O scheduling conflicts (e.g., to avoid assigning a data unit to a buffer when there are no available write operations to that buffer on account of other components currently reading content from the buffer).

The arbitration circuitry 220 is also configured to maintain ingress queues 228, according to some embodiments, which are used to manage the order in which data units are processed from the buffers in the ingress buffer memory 224. Each data unit, or the buffer locations(s) in which the data unit is stored, is said to belong to one or more constructs referred to as queues. Typically, a queue is a set of memory locations (e.g., in the ingress buffer memory 224) arranged in some order by metadata describing the queue. For example, each queue comprises a linked list of memory locations, in an embodiment. The memory locations may (and often are) non-contiguous relative to their addressing scheme and/or physical or logical arrangement.

In some embodiments, the sequence of constituent data units as arranged in a queue generally corresponds to an order in which the data units or data unit portions in the queue will be released and processed. Such queues are known as first-in-first-out (“FIFO”) queues, though in other embodiments other types of queues may be utilized. In some embodiments, the number of data units or data unit portions assigned to a given queue at a given time may be limited, either globally or on a per-queue basis, and this limit may change over time.

The ingress portion 204-xa also includes an ingress queue manager 230. The ingress queue manager 230 is configured to control i) storage of packet data to the ingress queues 228 and ii) reading of packet data from the ingress queues 228. In an embodiment, the ingress queue manager 230 is configured to maintain i) write pointers (sometimes referred to as “tail pointers”) for writing packet data to the ingress queues 228, and ii) read pointers (sometimes referred to as “head pointers”) for reading packet data from the ingress queues 228. The ingress queue manager 230 is also configured to combines a first ingress queue 228 corresponding to a first port 208 with a second ingress queue 228 corresponding to an inactive second port 208 to form a composite ingress queue that can operate at a higher speed than speeds at which the first ingress queue 228 and the second ingress queue 228 can operate individually, according to an embodiment. For example, when the first port 208 is operating at a high transmission rate and the second port 208 is inactive, the ingress queue manager 230 operates to combine the first ingress queue 228 corresponding to the first port 208 with the second ingress queue 228 corresponding to an inactive second port 208 to form a composite ingress queue that can operate at a higher speed than speeds at which the first ingress queue 228 and the second ingress queue 228 can operate individually, according to an embodiment.

The ingress portion 204-xa also includes an ingress packet processor 232 that is configured to perform ingress processing operations for packets such as one of, or any suitable combination of two or more of: packet classification, tunnel termination, L2 forwarding lookups, L3 forwarding lookups, etc., according to various embodiments. For example, the ingress packet processor 232 includes an L2 forwarding database and/or an L3 forwarding database, and the ingress packet processor 232 performs L2 forwarding lookups and/or L3 forwarding lookups to determine target ports for packets. In some embodiments, the ingress packet processor 232 uses header information in packets to perform L2 forwarding lookups and/or L3 forwarding lookups.

The ingress arbitration circuitry 220 is configured to release a certain number of data units (or portions of data units) from ingress queues 228 for processing (e.g., by the ingress packet processor 232) or for transfer (e.g., via the interconnect 216) each clock cycle or other defined period of time. The next data unit (or portion of a data unit) to release may be identified using one or more ingress queues 228. For instance, respective ingress ports 208 (or respective groups of ingress ports 208) are assigned to respective ingress queues 228, and the ingress arbitration circuitry 220 selects queues 228 from which to release one or more data units (or portions of data units) according to a selection scheme, such as a round-robin scheme or another suitable selection scheme, in some embodiments. Additionally, when ingress queues 228 are FIFO queues, the ingress arbitration circuitry 220 selects a data unit (or a portion of a data unit) from a head of a FIFO ingress queue 228, which corresponds to a data unit (or portion of a data unit) that has been in the FIFO ingress queue 228 for a longest time, in some embodiments.

In various embodiments, any of various suitable techniques are utilized to identify a particular ingress queues 228 from which to release a data unit (or a portion of a data unit) at a given time. For example, as discussed above, the ingress arbitration circuitry 220 retrieves data units (or portions of data units) from the multiple ingress queues 228 in a round-robin manner, in some embodiments. As other examples, the ingress arbitration circuitry 220 selects ingress queues 228 from which to retrieve data units (or portions of data units) using a pseudo-random approach, a probabilistic approach, etc., according to some embodiments.

In some embodiments, each of at least some ingress queues 228 is weighted by an advertised transmission rate of a corresponding ingress port 208. As an illustrative example, for every one data unit released from an ingress queue 228 corresponding to a 100 Mbps ingress port 208, ten data units are released from a queue corresponding to a 1 Gbps ingress port 228. The length and/or average age of an ingress queue 228 is also (or instead) utilized to prioritize queue selection. In another embodiment, a downstream component within the ingress portion 204-xa (or within an egress portion 204-xb) instructs the arbitration circuitry 220 to release data units corresponding to certain ingress queues 228. Hybrid approaches are used, in some examples. For example, one of the longest queues 228 is selected each odd clock cycle, whereas any of the ingress queues 228 are pseudorandomly selected every even clock cycle. In an embodiment, a token-based mechanism is utilized for releasing data units from ingress queues 228.

Yet other queue selection mechanisms are also possible. The techniques described herein are not specific to any one of these mechanisms, unless otherwise stated.

In some embodiments, ingress queues 228 correspond to specific groups of related traffic, also referred to as priority sets or classes of service. For instance, all packets carrying VOIP traffic are assigned to a first ingress queue 228, while all data units carrying Storage Area Network (“SAN”) traffic are assigned to a different second ingress queue 228. As another example, each of these queues 228 are weighted differently, so as to prioritize certain types of traffic over other traffic, in some embodiments. Moreover, different ingress queues 228 correspond to specific combinations of ingress ports 208 and priority sets, in some embodiments. For example, a respective set of multiple queues 228 correspond to each of at least some of the ingress ports 208, with respective queues 228 in the set of multiple queues 228 corresponding to respective priority sets.

Generally, when the ingress portion 204-xa is finished processing packets, the packets are transferred to one or more egress portions 204-xb via the interconnect 216. Transferring a data unit from an ingress portion 204-xa to an egress portions 204-xb comprises releasing (or dequeuing) the data unit and transferring the data unit to the egress portion 204-xb via the interconnect 216, according to an embodiment.

The egress portion 204-xb comprises circuitry 248 (sometimes referred to herein as “traffic manager circuitry 248”) that is configured to control the flow of data units from the ingress portions 204-xa to one or more other components of the egress portion 204-xb. The egress portion 204-xb is coupled to an egress buffer memory 252 that is configured to store egress buffers. A buffer manager (not shown) within the traffic manager circuitry 248 temporarily stores data units received from one or more ingress portions 204-xa in egress buffers as they await processing by one or more other components of the egress portion 204-xb. The buffer manager of the traffic manager circuitry 248 is configured to operate in a manner similar to the buffer manager of the ingress arbiter 220 discussed above.

The egress buffer memory 252 (and buffers of the egress buffer memory 252) is structured the same as or similar to the ingress buffer memory 224 (and buffers of the ingress buffer memory 224) discussed above. For example, each data unit received by the egress portion 204-xb is stored in one or more entries within one or more buffers, which entries are marked as utilized to prevent newly received data units from overwriting data units that are already buffered in the egress buffer memory 252. After a data unit is released from the egress buffer memory 252, the one or more entries in which the data unit is buffered in the egress buffer memory 252 are then marked as available for storing newly received data units, in some embodiments.

Generally, buffers in the egress buffer memory 252 comprises a variety of buffers or sets of buffers, each utilized for varying purposes and/or components within the egress portion 204-xb.

The buffer manager (not shown) is configured to manage use of the egress buffers 252. The buffer manager performs, for example, one of or any suitable combination of the following: allocates and deallocates specific segments of memory for buffers, creates and deletes buffers within that memory, identifies available buffer entries in which to store a data unit, maintains a mapping of buffers entries to data units stored in those buffers entries (e.g., by a packet sequence number assigned to each packet when the first the first data unit in that packet was received), marks a buffer entry as available when a data unit stored in that buffer is dropped, sent, or released from the buffer, determines when a data unit is to be dropped because it cannot be stored in a buffer, performs garbage collection on buffer entries for data units (or portions thereof) that are no longer needed, etc., in various embodiments.

The traffic manager circuitry 248 is also configured to maintain egress queues 256, according to some embodiments, that are used to manage the order in which data units are processed from the egress buffers 252. The egress queues 256 are structured the same as or similar to the ingress queues 228 discussed above.

In an embodiment, different egress queues 256 may exist for different destinations. For example, each egress port 212 is associated with a respective set of one or more egress queues 256. The egress queue 256 to which a data unit is assigned may, for instance, be selected based on forwarding information indicating the target port determined for the packet should.

In some embodiments, different egress queues 256 correspond to respective flows or sets of flows. That is, packets for each identifiable traffic flow or group of traffic flows is assigned a respective set of one or more egress queues 256. In some embodiments, different egress queues 256 correspond to different classes of traffic, QoS levels, etc.

In some embodiments, egress queues 256 correspond to respective egress ports 212 and/or respective priority sets. For example, a respective set of multiple queues 256 corresponds to each of at least some of the egress ports 212, with respective queues 256 in the set of multiple queues 256 corresponding to respective priority sets.

Generally, when the egress portion 204-xb receives packets from ingress portions 204-xa via the interconnect 116, the traffic manager circuitry 248 stores (or “enqueues”) the packets in egress queues 256.

The ingress buffer memory 224 corresponds to a same or different physical memory as the egress buffer memory 252, in various embodiments. In some embodiments in which the ingress buffer memory 224 and the egress buffer memory 252 correspond to a same physical memory, ingress buffers 224 and egress buffers 252 are stored in different portions of the same physical memory, allocated to ingress and egress operations, respectively.

In some embodiments in which the ingress buffer memory 224 and the egress buffer memory 252 correspond to a same physical memory, ingress buffers 224 and egress buffers 252 include at least some of the same physical buffers, and are separated only from a logical perspective. In such an embodiment, metadata or internal markings may indicate whether a given individual buffer entry belongs to an ingress buffer 224 or egress buffer 252. To avoid contention when distinguished only in a logical sense, ingress buffers 224 and egress buffers 252 may be allotted a certain number of entries in each of the physical buffers that they share, and the number of entries allotted to a given logical buffer is said to be the size of that logical buffer. In some such embodiments, when a packet is transferred from the ingress portion 204-xa to the egress portion 204-xb within a same packet processing module 204, instead of copying the packet from an ingress buffer entry to an egress buffer, the data unit remains in the same buffer entry, and the designation of the buffer entry (e.g., as belonging to an ingress queue versus an egress queue) changes with the stage of processing.

The egress portion 204-xb also includes an egress queue manager 260. The egress queue manager 260 is configured to control i) storage of packet data to the egress queues 256 and ii) reading of packet data from the egress queues 256. In an embodiment, the egress queue manager 260 is configured to maintain i) write pointers (sometimes referred to as “tail pointers”) for writing packet data to the egress queues 256, and ii) read pointers (sometimes referred to as “head pointers”) for reading packet data from the egress queues 256. The egress queue manager 260 is also configured to combines a first egress queue 256 corresponding to a first port 212 with a second egress queue 256 corresponding to an inactive second port 212 to form a composite egress queue that can operate at a higher speed than speeds at which the first egress queue 256 and the second egress queue 256 can operate individually, according to an embodiment. For example, when the first port 212 is operating at a high transmission rate and the second port 212 is inactive, the egress queue manager 260 operates to combine the first egress queue 256 corresponding to the first port 212 with the second egress queue 256 corresponding to an inactive second port 212 to form a composite egress queue that can operate at a higher speed than speeds at which the first egress queue 256 and the second egress queue 256 can operate individually, according to an embodiment.

The egress portion 204-xb also includes an egress packet processor 268 that is configured to perform egress processing operations for packets such as one of, or any suitable combination of two or more of: packet duplication (e.g., for multicast packets), header alteration, rate limiting, traffic shaping, egress policing, flow control, maintaining statistics regarding packets, etc., according to various embodiments. As an example, when a header of a packet is to be modified (e.g., to change a destination address, add a tunneling header, remove a tunneling header, etc.) the egress packet processor 268 modifies header information in the egress buffers 252, in some embodiments.

In an embodiment, the egress packet processor 268 is coupled to a group of egress ports 212 via egress arbitration circuitry 272 that is configured to regulate access to the group of egress ports 212 by the egress packet processor 268.

In some embodiments, the egress packet processor 268 is additionally or alternatively coupled to suitable destinations for packets other than egress ports 212, such as one or more internal central processing units (not shown), one or more storage subsystems, etc.

In the course of processing a data unit, the egress packet processor 268 may replicate a data unit one or more times. For example, a data unit may be replicated for purposes such as multicasting, mirroring, debugging, and so forth. Thus, a single data unit may be replicated, and stored in multiple egress queues 256. Hence, though certain techniques described herein may refer to the original data unit that was received by the network device 200, it will be understood that those techniques will equally apply to copies of the data unit that have been generated by the network device for various purposes. A copy of a data unit may be partial or complete. Moreover, there may be an actual physical copy of the data unit in egress buffers 252, or a single copy of the data unit 252 may be linked from a single buffer location (or single set of locations) in the egress buffers 252 to multiple egress queues 256.

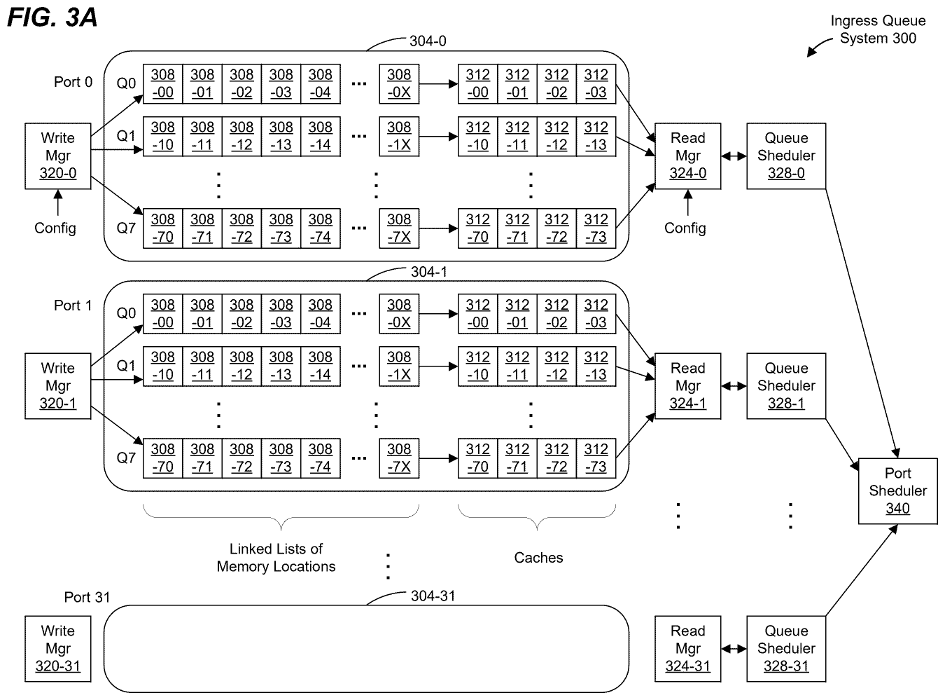

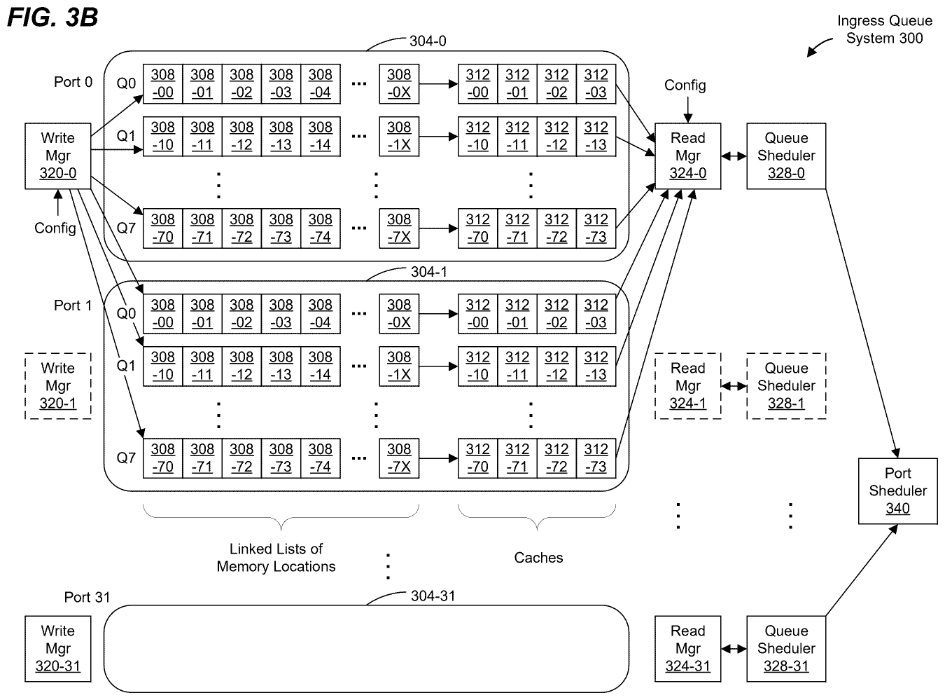

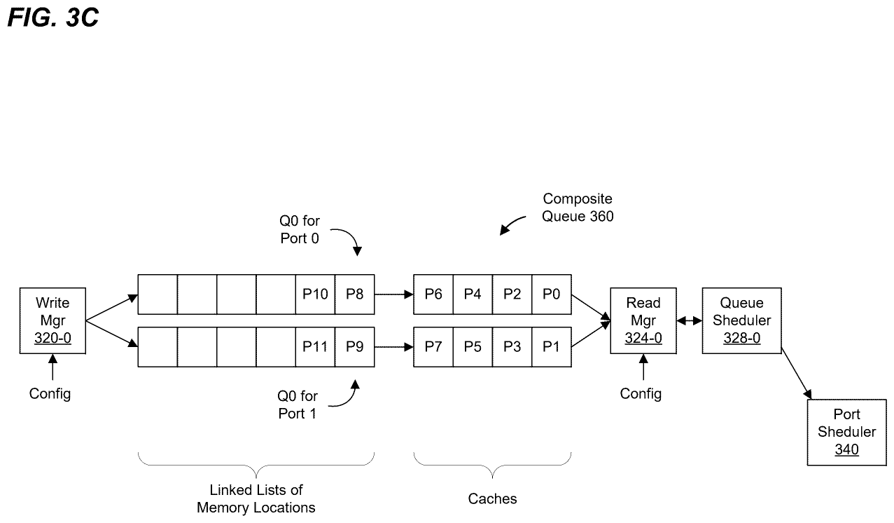

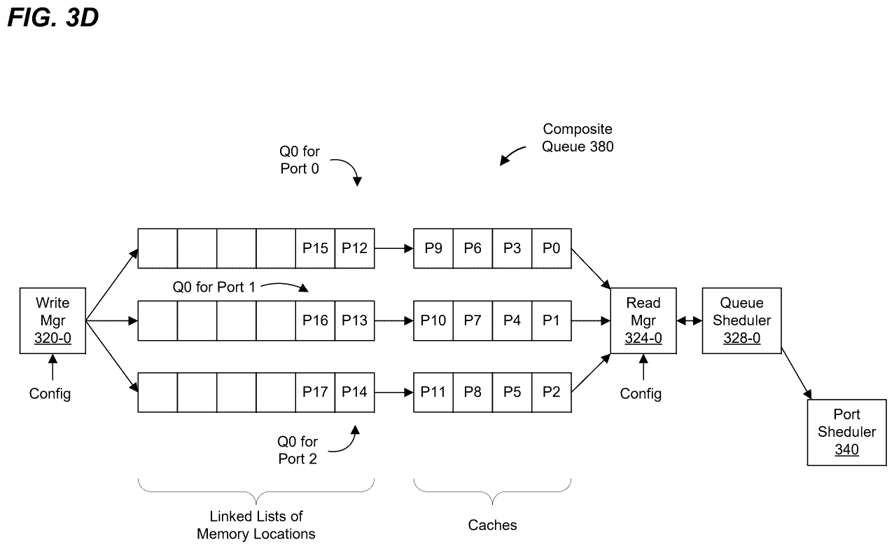

FIG. 3A is a simplified block diagram of an example ingress queueing system 300 of a network device, according to an embodiment. As will be described in more detail below, the ingress queueing system 300 is configured to combine a first ingress queue corresponding to a first port with a second ingress queue corresponding to an inactive second port to form a composite egress queue that can operate at a higher speed than speeds at which the first ingress queue and the second ingress queue can operate individually, according to an embodiment. A respective ingress queueing system 300 is implemented in each of one or more of the ingress portions 204-xa of FIG. 2, according to an embodiment, and FIG. 3A is described with reference to FIG. 2 for ease of explanation. In other embodiments, the ingress queueing system 300 is implemented in another suitable network device having a suitable structure different than the network device 200 of FIG. 2. In other embodiment, the network device 200 includes another suitable ingress queueing system different than the example ingress queueing system 300 of FIG. 3A.

The ingress queueing system 300 is coupled to a plurality of ports and is configured to store packets received via the plurality of ports. For example, in an embodiment in which the ingress queueing system 300 is implemented in the ingress portions 204-1a of FIG. 2, the ingress queueing system 300 is coupled to the ports 208-1 and is configured to store packets received via the ports 208-1.

FIG. 3A illustrates the ingress queueing system 300 operating in a state in which all the ports to which the ingress queueing system 300 are coupled are active. For example, the ports to which the ingress queueing system 300 are coupled are operating at one or more transmission rates that are below a threshold, in an embodiment.

The ingress queueing system 300 includes a respective set 304 of queues Q for each port among the plurality of ports. Although FIG. 3A illustrates eight queues Q in each set 304, each set 304 includes another suitable number of queues Q (e.g., one, two, etc., or more than eight), in other embodiments. Also, although FIG. 3A illustrates 32 sets 304 corresponding to 32 ports, ingress queueing system 300 includes another suitable number of sets 304 corresponding to another suitable number of ports different than 32.

Each queue Q in each set 304 comprises a respective plurality of elements 308 implemented in one or more memory banks. In an embodiment, each plurality of elements 308 is implemented as a respective linked list of elements 308 in the one or more memory banks. In an embodiment, each queue Q in each set 304 also comprises a respective plurality of elements 312 implemented as a cache of storage elements distinct from the one or more memory banks. For example, each respective plurality of elements 312 comprises a first-in-first-out (FIFO) memory structure distinct from the one or more memory banks in which the linked list of elements 308 is stored.

In an embodiment, the cache of elements 312 is configured to provide a higher access rate (e.g., read access rate and/or write access rate) as compared to the access rate provided by the one or more memory banks in which the elements 308 are stored. In some such embodiments, a per-element cost of the elements 312 (in terms of fabrication cost and/or integrated circuit (IC) chip area) is higher than a per-element cost of the elements 308. Thus, in some embodiments, a quantity of elements 312 in each cache is kept significantly less than a quantity of storage elements in the one or more memory banks that are available for the elements 308 to reduce costs (in terms of fabrication cost and/or IC chip area).

A respective write manager circuit 320 is coupled to a respective set 304 of queues Q. The respective write manager circuit 320 is configured to store packet data received via the respective port to the respective set 304 of queues Q. For example, the write manager circuit 320-0 stores packet data received via Port 0 to the set 304-0 of queues Q; the write manager circuit 320-1 stores packet data received via Port 1 to the set 304-1 of queues Q; and so on. In embodiments in which at least portions of the queues Q are implemented as linked lists, the write manager circuit 320 is configured to maintain tail pointers corresponding to the queues Q in the respective set 304, and the write manager circuit 320 updates tail pointers in connection with storing packet data in the queues Q.

As will be described further below, the write manager circuit 320-0 is also coupled to the set 304-1 of queues Q that correspond to Port 1 (which is not shown in FIG. 3A), and the write manager circuit 320-0 is configured to store packet data received via the Port 0 to both i) the set 304-0 of queues Q and ii) the set 304-1 of queues Q when the Port 1 is inactive.

In some embodiments, the ingress queues Q in each set 304 correspond to specific groups of related traffic, such as priority sets or classes of service, and the corresponding write manager circuit 320 is configured to write packet data corresponding to respective priority sets/classes of service to respective queues Q in the set 304. As merely an illustrative example, all packets received via a port carrying VoIP traffic are stored in a first ingress queue Q in the corresponding set 304, while all data units received via the port carrying SAN traffic are stored in a different second queue Q in the corresponding set 304.

A respective read manager circuit 324 is coupled to a respective set 304 of queues Q. The respective read manager circuit 324 is configured to read packet data from the respective set 304 of queues Q. For example, the read manager circuit 324-0 reads packet data from the set 304-0 of queues Q; the read manager circuit 324-1 reads packet data from the set 304-1 of queues Q; and so on. In embodiments in which at least portions of the queues Q are implemented as linked lists, the read manager circuit 324 is configured to maintain head pointers corresponding to the queues Q in the respective set 304, and the read manager circuit 324 updates head pointers in connection with reading packet data from the queues Q. In embodiments in which at least portions of the queues Q are implemented as caches of elements 312, the read manager circuit 324 is configured to i) read packet data from the caches of elements 312, ii) transfer data from linked lists of elements 308 to the caches of elements 312, and iii) update head pointers in connection with transferring packet data from the linked lists of elements 308 to the caches of elements 312.

As will be described further below, the read manager circuit 324-0 is also coupled to the set 304-1 of queues Q that correspond to Port 1 (which is not shown in FIG. 3A), and the read manager circuit 324-0 is configured to read packet data received via the Port 0 from both i) the set 304-0 of queues Q and ii) the set 304-1 of queues Q when the Port 1 is inactive.

A respective queue scheduler circuit 328 is configured to prompt the respective read manager circuit 324 to read packet data from particular queues Q in the respective set 304, and the read manager circuit 324 is configured to read packet data from particular queues Q in the set 304 in response to the prompts from the queue scheduler circuit 328, in an embodiment.

In an embodiment, each queue scheduler circuit 328 is configured to selects queues Q within the respective set 304 from which packet data is to be read according to a suitable selection scheme. In various embodiments, the selection scheme involves one of or any suitable combination of two or more of: i) selection based on a round-robin scheme, ii) selection based on a pseudo-random approach, ii) selection based on a probabilistic approach, iii) selection based on lengths of queues Q in the set 304, etc. Hybrid approaches are used, in some examples. For instance, one of the longest queues Q is selected each odd clock cycle, whereas any of the other queues Q is pseudorandomly selected every even clock cycle.

In some embodiments, each of at least some ingress queues 228 is weighted by an advertised transmission rate of a corresponding ingress port 208. As an illustrative example, for every one data unit released from an ingress queue 228 corresponding to a 100 Mbps ingress port 208, ten data units are released from a queue corresponding to a 1 Gbps ingress port 228. The length and/or average age of an ingress queue 228 is also (or instead) utilized to prioritize queue selection. In another embodiment, a downstream component within the ingress portion 204-xa (or within an egress portion 204-xb) instructs the arbitration circuitry 220 to release data units corresponding to certain ingress queues 228. Yet other queue selection mechanisms are also possible. The techniques described herein are not specific to any one of these mechanisms, unless otherwise stated.

A port scheduler circuit 340 is configured to select a port, from amongst the plurality of ports, from which packet data is to be forwarded to another component of the network device (e.g., a packet processor such as the corresponding ingress packet processor 232, an interconnect such as the interconnect 216, a egress queue such as one of the egress queues 256, etc.) during a particular unit of time, e.g., during a particular clock cycle, during a particular set of multiple clock cycles, etc. The port scheduler circuit 340 is configured to prompt the queue scheduler circuits 328, at different times, to initiate reading packet data from the sets 304, and each queue scheduler circuits 328 is configured to prompt the corresponding read manager circuit 324 to read packet data from the corresponding set 304 in response to a prompt from the port scheduler circuit 340, in an embodiment.

In an embodiment, the port scheduler circuit 340 is configured to select ports according to a suitable selection scheme. In various embodiments, the selection scheme involves one of or any suitable combination of two or more of: i) selection based on a round-robin scheme, ii) selection based a pseudo-random approach, ii) selection based a probabilistic approach, iii) selection based on transmission rates of the ports, etc. As an illustrative example, the selection scheme operates such that, for every one data unit output from a set 304 corresponding to a 100 Mbps port, ten data units are released from a set 304 corresponding to a 1 G port. Yet other port selection mechanisms are also possible. The techniques described herein are not specific to any one of these mechanisms, unless otherwise stated.

In an embodiment, the write management circuits 320 and the read management circuits 324 are included in a corresponding ingress queue manager 230. In an embodiment, the queue scheduler circuits 328 and the port scheduler circuit 340 are included in a corresponding ingress arbiter 220.

FIG. 3B is a simplified block diagram of the ingress queueing system 300 when operating in a state in which one or more of the ports to which the ingress queueing system 300 are coupled are inactive. As will be described in more detail below, the ingress queueing system 300 combines a first ingress queue corresponding to a first port with a second ingress queue corresponding to an inactive second port to form a composite egress queue that operates at a higher speed than speeds at which the first ingress queue and the second ingress queue can operate individually, according to an embodiment.

In the scenario illustrated in FIG. 3B, Port 0 is active and at least Port 1 is inactive. In an embodiment, the write manager circuit 320-1, the read manager circuit 324-1, and the queue scheduler circuit 328-1, which all correspond to Port 1, are inactive, which is indicated in FIG. 3B by showing the write manager circuit 320-1, the read manager circuit 324-1, and the queue scheduler circuit 328-1 with dashed lines. In an embodiment, one or more of the write manager circuit 320-1, the read manager circuit 324-1, and the queue scheduler circuit 328-1 are put into a low power state (sometimes referred to as a “sleep state”) to save power.

As briefly discussed above, and as shown in FIG. 3B, the write manager circuit 320-0 is coupled to i) the set 304-0 of queues Q corresponding to Port 0 and ii) the set 304-1 of queues Q corresponding to Port 1. The write manager circuit 320-0 is configured to store packet data received via the Port 0 to both i) the set 304-0 of queues Q and ii) the set 304-1 of queues Q when Port 1 is inactive. Although FIG. 3B illustrates the write manager circuit 320-0 being coupled to all of the queues Q in the set 304-1, the write manager circuit 320-0 is coupled to less than all of the queues Q in the set 304-1, in another embodiment.

The write manager circuit 320-0 is configured to operate a composite queue that combines a first queue in the set 304-0 with a second queue in the set 304-1. In an embodiment, the write manager circuit 320-0 is configured to operate the composite queue at a first higher write speed than write speeds at which the first queue and the second queue can operate individually. The write manager circuit 320-0 is configured to store packet data received via the Port 0 to the composite queue. The write manager circuit 320-0 is configured to store packet data received via the Port 0 to the composite queue at the write speed that is higher than the write speeds at which the first queue and the second queue can operate individually, according to an embodiment.

As an illustrative example, the write manager circuit 320-0 is configured to i) operate a composite queue that combines queue Q0 in the set 304-0 with queue Q0 in the set 304-1, and ii) store packet data received via the Port 0 to the composite queue that includes queue Q0 in the set 304-0 and queue Q0 in the set 304-1, in an embodiment.

Similarly, the read manager circuit 324-0 is configured to operate the composite queue that combines the first queue in the set 304-0 with the second queue in the set 304-1. In an embodiment, the read manager circuit 324-0 is configured to operate the composite queue at a higher read speed than read speeds at which the first queue and the second queue can operate individually. The read manager circuit 324-0 is configured to read packet data received via the Port 0 from the composite queue. The read manager circuit 324-0 is configured to read packet data received via the Port 0 from the composite queue at the read speed that is higher than the read speeds at which the first queue and the second queue can operate individually, according to an embodiment.

As an illustrative example, the read manager circuit 324-0 is configured to i) operate the composite queue that combines queue Q0 in the set 304-0 with queue Q0 in the set 304-1, and ii) read packet data received via the Port 0 from the composite queue that includes queue Q0 in the set 304-0 and queue Q0 in the set 304-1, in an embodiment.

In an embodiment, the write manager circuit 320-0 is selectively configurable to operate i) in the manner described with reference to FIG. 3A and ii) in the manner described with reference to FIG. 3B. For example, the write manager circuit 320-0 receives configuration information that indicates i) whether the read manager circuit 320-0 is to operate in the manner described with reference to FIG. 3A, and ii) whether the write manager circuit 320-0 is to operate in the manner described with reference to FIG. 3B.

In an embodiment, the read manager circuit 324-0 is selectively configurable to operate i) in the manner described with reference to FIG. 3A and ii) in the manner described with reference to FIG. 3B. For example, the read manager circuit 324-0 receives configuration information that indicates i) whether the read manager circuit 324-0 is to operate in the manner described with reference to FIG. 3A, and ii) whether the read manager circuit 324-0 is to operate in the manner described with reference to FIG. 3B.

FIG. 3C is a simplified block diagram showing the ingress queueing system 300 operating a composite queue 360 for Port 0 when Port 1 is inactive, the composite queue 360 including i) queue Q0 in the set 304-0 corresponding to Port 0 and ii) queue Q0 in the set 304-1 corresponding to Port 1, according to an embodiment.

In the example of FIG. 3C, packet data P0-P11 are stored in elements of the composite queue 360, and the composite queue 360 maintains an order in which the packet data P0-P11 were received via Port 0. The numerical suffix in the packet data P0-P11 indicates the order in which the packet data P0-P11 were received via Port 0. For example, packet data P0 was received first amongst the packet data P0-P11, and packet data P11 was received last amongst the packet data P0-P11. In an embodiment, P0-P11 denote different packets that were received via Port 0. In another embodiment, P0-P11 denote different segments of one or more packets that were received via Port 0.

The write manager circuit 320-0 is configured alternately store the packet data P0-P11 to queue Q0 in the set 304-0 and queue Q0 in the set 304-1 according to the order which the packet data P0-P11 were received via Port 0 and at the higher speed. For example, the write manager circuit 320-0 alternately stores the packet data P0-P11 to queue Q0 in the set 304-0 and queue Q0 in the set 304-1 in a ping pong manner. In an embodiment, the write manager circuit 320-0 maintains a linked list of at least the packet data of the composite queue 360 that are not stored in the caches.

In an embodiment, the write manager circuit 320-0 updates a tail pointer corresponding to the composite queue 360 in connection with storing packet data to the composite queue 360. In an embodiment, the tail pointer alternates to point to queue Q0 in the set 304-0 and queue Q0 in the set 304-1 in connection with storing packet data to the composite queue 360. For example, the tail pointer alternates to point to queue Q0 in the set 304-0 and queue Q0 in the set 304-1 in a ping pong manner in connection with storing packet data to the composite queue 360.

Similarly, the read manager circuit 324-0 is configured to alternately read the packet data P0-P11 from queue Q0 in the set 304-0 and queue Q0 in the set 304-1 according to the order in which the packet data P0-P11 were stored to the composite queue 360 and at the higher speed. For example, the read manager circuit 324-0 alternately reads the packet data P0-P11 from queue Q0 in the set 304-0 and queue Q0 in the set 304-1 in a ping pong manner.

In an embodiment, the read manager circuit 324-0 updates a head pointer corresponding to the composite queue 360 in connection with reading packet data from the composite queue 360. In an embodiment, the head pointer alternates to point to queue Q0 in the set 304-0 and queue Q0 in the set 304-1 in connection with reading packet data from the composite queue 360. For example, the read pointer alternates to point to queue Q0 in the set 304-0 and queue Q0 in the set 304-1 in a ping pong manner in connection with reading packet data from the composite queue 360.

Although FIG. 3C illustrates a composite queue 360 that comprises two queues Q0 corresponding to two ports, a composite queue comprises other suitable quantities of queues corresponding to other suitable quantities of ports, in other embodiments, such as a composite queue comprising three ports corresponding to three respective ports, a composite queue comprising four ports corresponding to four respective ports, etc.

FIG. 3D is a simplified block diagram showing the ingress queueing system 300 operating a composite queue 380 for Port 0 when Port 1 and Port 2 are inactive, the composite queue 380 including i) queue Q0 in the set 304-0 corresponding to Port 0, ii) queue Q0 in the set 304-1 corresponding to Port 1, and iii) queue Q0 in the set 304-2 corresponding to Port 2, according to another embodiment.

In the example of FIG. 3D, packet data P0-P17 are stored in elements of the composite queue 360, and the composite queue 360 maintains an order in which the packet data P0-P17 were received via Port 0. The numerical suffix in the packet data P0-P17 indicates the order in which the packet data P0-P17 were received via Port 0. For example, packet data P0 was received first amongst the packet data P0-P17, and packet data P17 was received last amongst the packet data P0-P17. In an embodiment, P0-P17 denote different packets P0-P17 that were received via Port 0. In another embodiment, P0-P17 denote different segments of one or more packets that were received via Port 0.

The write manager circuit 320-0 is configured alternately store the packet data P0-P17 to i) queue Q0 in the set 304-0, ii) queue Q0 in the set 304-1, and iii) queue Q0 in the set 304-2, according to the order which the packet data P0-P17 were received via Port 0. For example, the write manager circuit 320-0 alternately stores the packet data P0-P17 to i) queue Q0 in the set 304-0, ii) queue Q0 in the set 304-1, and iii) queue Q0 in the set 304-2, in a round-robin manner. The write manager circuit 320-0 alternately stores the packet data P0-P17 to i) queue Q0 in the set 304-0, ii) queue Q0 in the set 304-1, and iii) queue Q0 in the set 304-2, in a suitable manner different than a round-robin manner, in other embodiments. In an embodiment, the write manager circuit 320-0 maintains a linked list of at least the packet data of the composite queue 380 that are not stored in the caches.

In an embodiment, the write manager circuit 320-0 updates a tail pointer corresponding to the composite queue 380 in connection with storing packet data to the composite queue 380. In an embodiment, the tail pointer alternates to point to i) queue Q0 in the set 304-0, ii) queue Q0 in the set 304-1, and iii) queue Q0 in the set 304-2, in connection with storing packet data to the composite queue 380. For example, the tail pointer alternates to point to i) queue Q0 in the set 304-0, ii) queue Q0 in the set 304-1, and iii) queue Q0 in the set 304-2, in a round-robin manner in connection with storing packet data to the composite queue 380.

Similarly, the read manager circuit 324-0 is configured to alternately read the packet data P0-P17 from i) queue Q0 in the set 304-0, ii) queue Q0 in the set 304-1, and iii) queue Q0 in the set 304-2, according to the order in which the packet data P0-P17 were stored to the composite queue 380. For example, the read manager circuit 324-0 alternately reads the packet data P0-P11 from i) queue Q0 in the set 304-0, ii) queue Q0 in the set 304-1, and iii) queue Q0 in the set 304-2, in a round-robin manner.

In an embodiment, the read manager circuit 324-0 updates a head pointer corresponding to the composite queue 380 in connection with reading packet data from the composite queue 380. In an embodiment, the head pointer alternates to point to i) queue Q0 in the set 304-0, ii) queue Q0 in the set 304-1, and iii) queue Q0 in the set 304-2, in connection with reading packet data from the composite queue 380. For example, the read pointer alternates to point to i) queue Q0 in the set 304-0, ii) queue Q0 in the set 304-1, and iii) queue Q0 in the set 304-2, in a round-robin manner in connection with reading packet data from the composite queue 380.

Although FIG. 3D illustrates the composite queue 380 comprising three queues Q0 corresponding to three respective ports, in other embodiments a composite queue comprises a suitable number of queues more than three (e.g., four, five, six, seven, eight, etc.) corresponding to another suitable number of ports more than three (e.g., four, five, six, seven, eight, etc.).

In some embodiments, a network device additionally or alternatively includes an egress having a structure similar to the ingress queueing system 300 discussed above with reference to FIGS. 3A-D. For instance, the egress queueing system 300 is configured to combine a first egress queue corresponding to a first port with a second egress queue corresponding to an inactive second port to form a composite egress queue that can operate at a higher speed than speeds at which the first ingress queue and the second ingress queue can operate individually, according to an embodiment. In an embodiment, a respective egress queueing system 300 is implemented in each of one or more of the egress portions 204-xb of FIG. 2, according to an embodiment. In other embodiments, an egress queueing system is implemented in another suitable network device having a suitable structure different than the network device 200 of FIG. 2. In other embodiments, the network device 200 includes another suitable egress queueing system.

The egress queueing system (having the structure similar to the ingress queueing system 300) is coupled to a plurality of ports and is configured to store packets that are to be transmitted via the plurality of ports. For example, in an embodiment in which the egress queueing system 300 is implemented in the egress portions 204-1b of FIG. 2, the egress queueing system is coupled to the ports 212-1 and is configured to store packets to be transmitted via the ports 212-1. The egress queueing system includes i) a write manager circuit similar to the write manager circuit 320-0 discussed above, and ii) a read manager circuit similar to the read manager circuit 324-0 discussed above, in an embodiment.

In an embodiment, such write management circuits and such read management circuits are included in a corresponding egress queue manager 260 (FIG. 2).

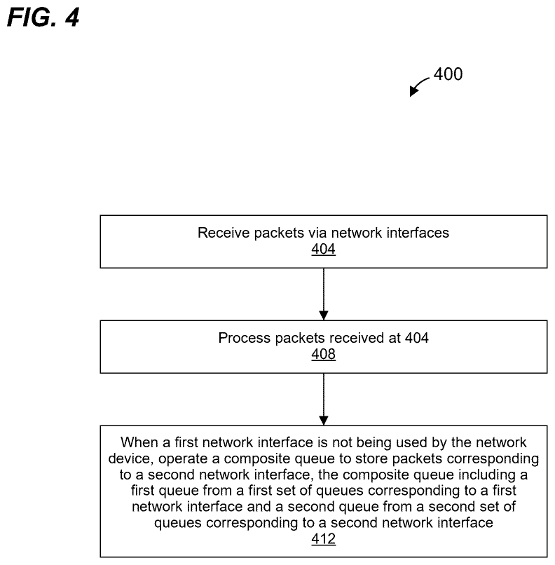

FIG. 4 is a flow diagram of an example method 400 for processing data units in a network device, according to an embodiment. The method 400 is implemented in a network device that includes i) a plurality of network interfaces, and ii) a plurality of sets of queues, and each set of queues corresponds to a respective network interface amongst at least some network interfaces of the plurality of network interfaces, according to an embodiment. The plurality of sets of queues includes a first set of queues corresponding to a first network interface and a second set of queues corresponding to a second network interface.

In an embodiment, the method 400 is implemented by a queue management system similar to the queue management system described with reference to FIGS. 3A-D, and FIG. 4 is described with reference to FIGS. 3A-D for ease of explanation. In other embodiments, the method 400 is implemented by another queue management system. In an embodiment, the method 400 is implemented by the network device 200 of FIG. 2, and FIG. 4 is described with reference to FIG. 2 for ease of explanation. In other embodiments, the method 400 is implemented in another suitable network device.

At block 404, packets are received via a plurality of network interfaces of the network device. For example, packets are received via the ports 208 (FIG. 2). As another example, packets are received via Port 0 (FIGS. 3A-D) and optionally one or more other ports.

At block 408, the network device processes packets received at block 404 to determine network interfaces, amongst the plurality of network interfaces, via which the packets are to be transmitted. In an embodiment, a packet processor of the network device processes packets received at block 404 to determine network interfaces, amongst the plurality of network interfaces, via which the packets are to be transmitted. For example, one or more ingress packet processors 232 process packets received at block 404 to determine network interfaces, amongst the plurality of network interfaces, via which the packets are to be transmitted.

At block 412, when the first network interface is not being used by the network device, the network device operates a composite queue to store packets corresponding to the second network interface, the composite queue including a first queue from the first set of queues and a second queue from the second set of queues. In an embodiment, operating the composite queue at block 412 comprises at least one of i) storing packet data to the composite queue at a first rate that is greater than a first maximum rate at which the first queue and the second queue are capable of storing packet data, and ii) reading packet data from the composite queue at a second rate that is greater than a second maximum rate at which the first queue and the second queue are capable of reading packet data. In some embodiments, the first rate is equal to the second rate, and/or the first maximum rate is equal to the second maximum rate. In other embodiments, the first rate is different than the second rate, and/or the first maximum rate is different than the second maximum rate.

For example, the ingress queue manager 230 operates the composite queue, in an embodiment. As another example, the egress queue manager 260 operates the composite queue, in another embodiment. As another example, the write manager circuit 320-0 and the read manager circuit 324 operate the composite queue 360, in an embodiment. As another example, the write manager circuit 320-0 and the read manager circuit 324 operate the composite queue 380, in another embodiment.

In an embodiment, operating the composite queue at block 412 comprises: in connection with storing packet data to the composite queue, alternately storing packet data to the first queue and the second queue; and in connection with reading packet data from the composite queue, alternately reading packet data from the first queue and the second queue.

In another embodiment, alternately storing packet data to the first queue and the second queue comprises: storing packet data to the first queue at a rate that is less than or equal to the first maximum rate, and storing packet data to the second queue at the rate that is less than or equal to the first maximum rate. In another embodiment, alternately reading packet data from the first queue and the second queue comprises: reading packet data from the first queue at a rate that is less than or equal to the second maximum rate, and reading packet data from the second queue at the rate that is less than or equal to the second maximum rate.

In another embodiment, the plurality of sets of queues further includes a third set of queues corresponding to a third network interface; and operating the composite queue at block 412 comprises operating the composite queue to further include a third queue from the third set of queues when the third network interface is not being used by the network device.

In another embodiment, operating the composite queue at block 412 comprises: in connection with storing packet data to the composite queue, alternately storing packet data to the first queue, the second queue, and the third queue; and in connection with reading packet data from the composite queue, alternately reading packet data from the first queue, the second queue, and the third queue.

In another embodiment, alternately storing packet data to the first queue, the second queue, and the third queue comprises alternately storing packet data to the first queue, the second queue, and the third queue in a round-robin manner; and alternately reading packet data from the first queue, the second queue, and the third queue comprises alternately reading packet data from the first queue, the second queue, and the third queue in the round-robin manner.

In another embodiment, operating the composite queue at block 412 comprises: in connection with alternately storing packet data to the first queue, the second queue, and the third queue: storing packet data to the first queue at a rate that is less than or equal to the first maximum rate, storing packet data to the second queue at the rate that is less than or equal to the first maximum rate, and storing packet data to the third queue at the rate that is less than or equal to the first maximum rate. In another embodiment, operating the composite queue at block 412 comprises: in connection with alternately reading packet data from the first queue, the second queue, and the third queue: reading packet data from the first queue at a rate that is less than or equal to the second maximum rate, reading packet data from the second queue at the rate that is less than or equal to the second maximum rate, and reading packet data from the third queue at the rate that is less than or equal to the second maximum rate.

In another embodiment, operating the composite queue at block 412 comprises: maintaining, by the network device, a linked list corresponding to the composite queue, the linked list including i) elements of the first queue from the first set of queues and ii) elements of the second queue from the second set of queues.

In another embodiment, the method 400 further comprises storing packet data received via the second network interface in the composite queue.

In another embodiment, the method 400 further comprises storing packet data to be transmitted via the second network interface in the composite queue.

Embodiment 1: A network device configured to operate in a communication network, the network device comprising: a plurality of network interfaces, each network interface configured to i) receive packets, and ii) transmit packets; a plurality of sets of queues, each set of queues corresponding to a respective network interface amongst at least some network interfaces of the plurality of network interfaces, the plurality of sets of queues including a first set of queues corresponding to a first network interface and a second set of queues corresponding to a second network interface; a packet processor configured to process packets received via the plurality of network interfaces to determine network interfaces, amongst the plurality of network interfaces, via which the packets are to be transmitted; and queue management circuitry configured to, when the first network interface is not being used by the network device, operate a composite queue to store packet data corresponding to the second network interface, the composite queue including a first queue from the first set of queues and a second queue from the second set of queues, wherein the queue management circuitry is configured to at least one of i) store packet data to the composite queue at a first rate that is greater than a first maximum rate at which the first queue and the second queue are capable of storing packet data, and ii) read packet data from the composite queue at a second rate that is greater than a second maximum rate at which the first queue and the second queue are capable of reading packet data.

Embodiment 2: The network device of embodiment 1, wherein the queue management circuitry is configured to: in connection with storing packet data to the composite queue, alternately store packet data to the first queue and the second queue; and in connection with reading packet data from the composite queue, alternately read packet data from the first queue and the second queue.

Embodiment 3: The network device of embodiment 2, wherein the queue management circuitry is configured to: in connection with alternately storing packet data to the first queue and the second queue: storing packet data to the first queue at a rate that is less than or equal to the first maximum rate, and storing packet data to the second queue at the rate that is less than or equal to the first maximum rate; and wherein the queue management circuitry is configured to: in connection with alternately reading packet data from the first queue and the second queue: reading packet data from the first queue at a rate that is less than or equal to the second maximum rate, and reading packet data from the second queue at the rate that is less than or equal to the second maximum rate.

Embodiment 4: The network device of any of embodiments 1, wherein the plurality of sets of queues further includes a third set of queues corresponding to a third network interface; and wherein the queue management circuitry configured to, when the third network interface is not being used by the network device, operate the composite queue to further include a third queue from the third set of queues.

Embodiment 5: The network device of embodiment 4, wherein the queue management circuitry is configured to: in connection with storing packet data to the composite queue, alternately store packet data to the first queue, the second queue, and the third queue; and in connection with reading packet data from the composite queue, alternately read packet data from the first queue, the second queue, and the third queue.

Embodiment 6: The network device of embodiment 5, wherein the queue management circuitry is configured to: in connection with storing packet data to the composite queue, alternately store packet data to the first queue, the second queue, and the third queue in a round-robin manner; and in connection with reading packet data from the composite queue, alternately read packet data from the first queue, the second queue, and the third queue in the round-robin manner.

Embodiment 7: The network device of embodiment 5, wherein the queue management circuitry is configured to: in connection with alternately storing packet data to the first queue, the second queue, and the third queue: storing packet data to the first queue at a rate that is less than or equal to the first maximum rate, storing packet data to the second queue at the rate that is less than or equal to the first maximum rate, and storing packet data to the third queue at the rate that is less than or equal to the first maximum rate; and wherein the queue management circuitry is configured to: in connection with alternately reading packet data from the first queue, the second queue, and the third queue: reading packet data from the first queue at a rate that is less than or equal to the second maximum rate, reading packet data from the second queue at the rate that is less than or equal to the second maximum rate, and reading packet data from the third queue at the rate that is less than or equal to the second maximum rate.

Embodiment 8: The network device of any of embodiments 1-7, wherein the queue management circuitry is configured to: maintain a linked list corresponding to the composite queue, the linked list including i) elements of the first queue from the first set of queues and ii) elements of the second queue from the second set of queues.

Embodiment 9: The network device of any of embodiments 1-8, wherein the queue management circuitry is configured to: operate the composite queue to store packet data received via the second network interface.

Embodiment 10: The network device of any of embodiments 1-8, wherein the queue management circuitry is configured to: operate the composite queue to store packet data to be transmitted by the network device via the second network interface.

Embodiment 11: A method for processing packets in a network device having i) a plurality of network interfaces, and ii) a plurality of sets of queues, each set of queues corresponding to a respective network interface amongst at least some network interfaces of the plurality of network interfaces, the plurality of sets of queues including a first set of queues corresponding to a first network interface and a second set of queues corresponding to a second network interface, the method comprising: receiving packets via a plurality of network interfaces of the network device; processing, by the network device, packets received via the plurality of network interfaces to determine network interfaces, amongst the plurality of network interfaces, via which the packets are to be transmitted; and when the first network interface is not being used by the network device, operating, by the network device, a composite queue to store packets corresponding to the second network interface, the composite queue including a first queue from the first set of queues and a second queue from the second set of queues, wherein operating the composite queue comprises at least one of i) storing packet data to the composite queue at a first rate that is greater than a first maximum rate at which the first queue and the second queue are capable of storing packet data, and ii) reading packet data from the composite queue at a second rate that is greater than a second maximum rate at which the first queue and the second queue are capable of reading packet data.

Embodiment 12: The method of embodiment 11, wherein operating the composite queue comprises: in connection with storing packet data to the composite queue, alternately storing packet data to the first queue and the second queue; and in connection with reading packet data from the composite queue, alternately reading packet data from the first queue and the second queue.

Embodiment 13: The method of embodiment 12, wherein alternately storing packet data to the first queue and the second queue comprises: storing packet data to the first queue at a rate that is less than or equal to the first maximum rate, and storing packet data to the second queue at the rate that is less than or equal to the first maximum rate; and wherein alternately reading packet data from the first queue and the second queue comprises: reading packet data from the first queue at a rate that is less than or equal to the second maximum rate, and reading packet data from the second queue at the rate that is less than or equal to the second maximum rate.

Embodiment 14: The method of embodiment 11, wherein the plurality of sets of queues further includes a third set of queues corresponding to a third network interface; and wherein operating the composite queue comprises operating the composite queue to further include a third queue from the third set of queues when the third network interface is not being used by the network device.

Embodiment 15: The method of embodiment 14, wherein operating the composite queue comprises: in connection with storing packet data to the composite queue, alternately storing packet data to the first queue, the second queue, and the third queue; and in connection with reading packet data from the composite queue, alternately reading packet data from the first queue, the second queue, and the third queue.

Embodiment 16: The method of embodiment 15, wherein alternately storing packet data to the first queue, the second queue, and the third queue comprises alternately storing packet data to the first queue, the second queue, and the third queue in a round-robin manner; and wherein alternately reading packet data from the first queue, the second queue, and the third queue comprises alternately reading packet data from the first queue, the second queue, and the third queue in the round-robin manner.

Embodiment 17: The method of embodiment 15, wherein operating the composite queue comprises: in connection with alternately storing packet data to the first queue, the second queue, and the third queue: storing packet data to the first queue at a rate that is less than or equal to the first maximum rate, storing packet data to the second queue at the rate that is less than or equal to the first maximum rate, and storing packet data to the third queue at the rate that is less than or equal to the first maximum rate; and wherein operating the composite queue comprises: in connection with alternately reading packet data from the first queue, the second queue, and the third queue: reading packet data from the first queue at a rate that is less than or equal to the second maximum rate, reading packet data from the second queue at the rate that is less than or equal to the second maximum rate, and reading packet data from the third queue at the rate that is less than or equal to the second maximum rate.

Embodiment 18: The method of any of embodiments 11-17, wherein operating the composite queue comprises: maintaining, by the network device, a linked list corresponding to the composite queue, the linked list including i) elements of the first queue from the first set of queues and ii) elements of the second queue from the second set of queues.

Embodiment 19: The method of any of embodiments 11-18, further comprising: storing packet data received via the second network interface in the composite queue.

Embodiment 20: The method of any of embodiments 11-18, further comprising: storing packet data to be transmitted via the second network interface in the composite queue.

At least some of the various blocks, operations, and techniques described above are suitably implemented utilizing dedicated hardware, such as one or more of discrete components, an integrated circuit, an ASIC, a programmable logic device (PLD), a processor executing firmware instructions, a processor executing software instructions, or any combination thereof. When implemented utilizing a processor executing software or firmware instructions, the software or firmware instructions may be stored in any suitable computer readable memory such as in a random access memory (RAM), a read-only memory (ROM), a solid state memory, etc. The software or firmware instructions may include machine readable instructions that, when executed by one or more processors, cause the one or more processors to perform various acts described herein.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A network device configured to operate in a communication network, the network device comprising:
a plurality of network interfaces, each network interface configured to i) receive packets, and ii) transmit packets;
a plurality of sets of queues, each set of queues corresponding to a respective network interface amongst at least some network interfaces of the plurality of network interfaces, the plurality of sets of queues including a first set of queues corresponding to a first network interface and a second set of queues corresponding to a second network interface;
a packet processor configured to process packets received via the plurality of network interfaces to determine network interfaces, amongst the plurality of network interfaces, via which the packets are to be transmitted; and
queue management circuitry configured to, when the first network interface is not being used by the network device, operate a composite queue to store packet data corresponding to the second network interface, the composite queue including a first queue from the first set of queues and a second queue from the second set of queues, wherein the queue management circuitry is configured to at least one of i) store packet data to the composite queue at a first rate that is greater than a first maximum rate at which the first queue and the second queue are capable of storing packet data, and ii) read packet data from the composite queue at a second rate that is greater than a second maximum rate at which the first queue and the second queue are capable of reading packet data.

2. The network device of claim 1, wherein the queue management circuitry is configured to:
in connection with storing packet data to the composite queue, alternately store packet data to the first queue and the second queue; and
in connection with reading packet data from the composite queue, alternately read packet data from the first queue and the second queue.

3. The network device of claim 2, wherein the queue management circuitry is configured to:
in connection with alternately storing packet data to the first queue and the second queue:
storing packet data to the first queue at a rate that is less than or equal to the first maximum rate, and
storing packet data to the second queue at the rate that is less than or equal to the first maximum rate; and
in connection with alternately reading packet data from the first queue and the second queue:
reading packet data from the first queue at a rate that is less than or equal to the second maximum rate, and
reading packet data from the second queue at the rate that is less than or equal to the second maximum rate.

4. The network device of claim 1, wherein the plurality of sets of queues further includes a third set of queues corresponding to a third network interface; and
wherein the queue management circuitry configured to, when the third network interface is not being used by the network device, operate the composite queue to further include a third queue from the third set of queues.

5. The network device of claim 4, wherein the queue management circuitry is configured to:
in connection with storing packet data to the composite queue, alternately store packet data to the first queue, the second queue, and the third queue; and
in connection with reading packet data from the composite queue, alternately read packet data from the first queue, the second queue, and the third queue.

6. The network device of claim 5, wherein the queue management circuitry is configured to:
in connection with storing packet data to the composite queue, alternately store packet data to the first queue, the second queue, and the third queue in a round-robin manner; and
in connection with reading packet data from the composite queue, alternately read packet data from the first queue, the second queue, and the third queue in the round-robin manner.

7. The network device of claim 5, wherein the queue management circuitry is configured to:
in connection with alternately storing packet data to the first queue, the second queue, and the third queue:
storing packet data to the first queue at a rate that is less than or equal to the first maximum rate,
storing packet data to the second queue at the rate that is less than or equal to the first maximum rate, and
storing packet data to the third queue at the rate that is less than or equal to the first maximum rate; and
in connection with alternately reading packet data from the first queue, the second queue, and the third queue:
reading packet data from the first queue at a rate that is less than or equal to the second maximum rate,
reading packet data from the second queue at the rate that is less than or equal to the second maximum rate, and
reading packet data from the third queue at the rate that is less than or equal to the second maximum rate.

8. The network device of claim 1, wherein the queue management circuitry is configured to:
maintain a linked list corresponding to the composite queue, the linked list including i) elements of the first queue from the first set of queues and ii) elements of the second queue from the second set of queues.

9. The network device of claim 1, wherein the queue management circuitry is configured to:
operate the composite queue to store packet data received via the second network interface.

10. The network device of claim 1, wherein the queue management circuitry is configured to:
operate the composite queue to store packet data to be transmitted by the network device via the second network interface.

11. A method for processing packets in a network device having i) a plurality of network interfaces, and ii) a plurality of sets of queues, each set of queues corresponding to a respective network interface amongst at least some network interfaces of the plurality of network interfaces, the plurality of sets of queues including a first set of queues corresponding to a first network interface and a second set of queues corresponding to a second network interface, the method comprising:
receiving packets via a plurality of network interfaces of the network device;
processing, by the network device, packets received via the plurality of network interfaces to determine network interfaces, amongst the plurality of network interfaces, via which the packets are to be transmitted; and
when the first network interface is not being used by the network device, operating, by the network device, a composite queue to store packets corresponding to the second network interface, the composite queue including a first queue from the first set of queues and a second queue from the second set of queues, wherein operating the composite queue comprises at least one of i) storing packet data to the composite queue at a first rate that is greater than a first maximum rate at which the first queue and the second queue are capable of storing packet data, and ii) reading packet data from the composite queue at a second rate that is greater than a second maximum rate at which the first queue and the second queue are capable of reading packet data.

12. The method of claim 11, wherein operating the composite queue comprises:
in connection with storing packet data to the composite queue, alternately storing packet data to the first queue and the second queue; and
in connection with reading packet data from the composite queue, alternately reading packet data from the first queue and the second queue.

13. The method of claim 12, wherein:
alternately storing packet data to the first queue and the second queue comprises:
storing packet data to the first queue at a rate that is less than or equal to the first maximum rate, and
storing packet data to the second queue at the rate that is less than or equal to the first maximum rate; and
alternately reading packet data from the first queue and the second queue comprises:
reading packet data from the first queue at a rate that is less than or equal to the second maximum rate, and
reading packet data from the second queue at the rate that is less than or equal to the second maximum rate.

14. The method of claim 11, wherein the plurality of sets of queues further includes a third set of queues corresponding to a third network interface; and
wherein operating the composite queue comprises operating the composite queue to further include a third queue from the third set of queues when the third network interface is not being used by the network device.

15. The method of claim 14, wherein operating the composite queue comprises:
in connection with storing packet data to the composite queue, alternately storing packet data to the first queue, the second queue, and the third queue; and
in connection with reading packet data from the composite queue, alternately reading packet data from the first queue, the second queue, and the third queue.

16. The method of claim 15, wherein:
alternately storing packet data to the first queue, the second queue, and the third queue comprises alternately storing packet data to the first queue, the second queue, and the third queue in a round-robin manner; and
alternately reading packet data from the first queue, the second queue, and the third queue comprises alternately reading packet data from the first queue, the second queue, and the third queue in the round-robin manner.

17. The method of claim 15, wherein operating the composite queue comprises:
in connection with alternately storing packet data to the first queue, the second queue, and the third queue:
storing packet data to the first queue at a rate that is less than or equal to the first maximum rate,
storing packet data to the second queue at the rate that is less than or equal to the first maximum rate, and
storing packet data to the third queue at the rate that is less than or equal to the first maximum rate; and
in connection with alternately reading packet data from the first queue, the second queue, and the third queue:
reading packet data from the first queue at a rate that is less than or equal to the second maximum rate,
reading packet data from the second queue at the rate that is less than or equal to the second maximum rate, and
reading packet data from the third queue at the rate that is less than or equal to the second maximum rate.

18. The method of claim 11, wherein operating the composite queue comprises:
maintaining, by the network device, a linked list corresponding to the composite queue, the linked list including i) elements of the first queue from the first set of queues and ii) elements of the second queue from the second set of queues.

19. The method of claim 11, further comprising:
storing packet data received via the second network interface in the composite queue.

20. The method of claim 11, further comprising:
storing packet data to be transmitted via the second network interface in the composite queue.
